(19) United States
(12) Patent Application Publication
(10) Pub. No.: US 2026/0049678 A1
(43) Pub. Date: Feb. 19, 2026

(54) Flexible Pipe Connector

(71) Applicant: MICHAEL ANTHONY DI MONTE, Highlands, NJ (US)

(72) Inventor: MICHAEL ANTHONY DI MONTE, Highlands, NJ (US)

(21) Appl. No.: 19/190,224

(22) Filed: Apr. 25, 2025

Related U.S. Application Data
(60) Provisional application No. 63/638,515, filed on Apr. 25, 2024.

(51) Int. Cl. F16L 21/00

(52) U.S. Cl. CPC F16L 21/005

(57) ABSTRACT

A flexible pipe connector

### CROSS-REFERENCE RELATED TO RELATED APPLICATIONS

The current application claims benefit and priority from U.S. Provisional Application No. 63/638,515, filed Apr. 25, 2024, pending. All the above-listed prior applications are incorporated by reference entirely herein.

### BACKGROUND

When a pipe clamp is tightened on the end of a flexible pipe connector, the round shape of the flexible pipe connector is often distorted. This distortion is caused by an interaction of several factors: first, the pipe clamp force is not uniformly distributed over the entire circumference of the end of the flexible pipe connector, which cause a stress-concentration on one or more locations around the circumference of the end of the flexible pipe connector; second, the flexibility of the material of the flexible pipe connector, and third, the material of the flexible pipe connector is not isotopically, including the strength, the thickness, and the purity, etc. practically is not equal in all directions. Therefore, when a clamp is tightened, the clamp is normally tightened on one end of the clamp, which would cause the transmission of the force from the clamp to the circumference of the end of the flexible pipe connector nonuniformly. The non-uniform force would further cause the stress concentrated at one location on the circumference and deform the flexible pipe connector at that specific location. When the material is deformed, it will further redistribute the stress to other locations and another stress-concentration will occur at a new location, which causes another deformation at the location. When this stress-concentration and the deformation occurs at a plurality of locations, the end of the flexible pipe connection becomes distorted rippling on the circumference. The rippling distortion on the end of the flexible pipe connector will form a gap between the pipe and the inner side of the flexible pipe connector, which will allow liquid to escape from the gap and cause leakage.

### BRIEF SUMMARY OF THE INVENTION

The invention is directed to a flexible pipe

It is to be understood that both the foregoing general description and the following detailed description are exemplary and explanatory only and are not restrictive of the invention.

### BRIEF DESCRIPTION OF THE DRAWINGS

It should be noted that the drawings are merely representative, are not necessarily drawn to scale, and are not intended to limit the scope of the present invention.

FIG. 1 is a perspective view of one embodiment of the invention.

FIG. 2 is a cross sectional view of one embodiment of the first pipe receiving end the invention.

FIG. 3 is a longitudinally sectional view of one embodiment of the invention.

### DETAILED DESCRIPTION

Before the present invention is described in greater detail, it is to be understood that this invention is not limited to particular embodiments described, and as such may, of course, vary. It is also to be understood that the terminology used herein is for the purpose of describing particular embodiments only, and is not intended to be limiting, since the scope of the present invention will be limited only by the appended claims.

Wherein a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all terms used herein have the same meaning as commonly understood by one of ordinary skill in the art to which this invention belongs. Although any methods and materials similar or equivalent to those described herein can be used in the practice or testing of the present invention, some potential and exemplary methods and materials may now be described. Any and all publications mentioned herein are incorporated herein by reference to disclose and describe the methods and/or materials in connection with which the publications are cited. It is understood that the present disclosure supersedes any disclosure of an incorporated publication to the extent there is a contradiction. It must be noted that as used herein and in the appended claims, the singular forms “a”, “an”, and “the” may also include the plural referents unless the context clearly dictates otherwise. It is further noted that the claims may be drafted to exclude any element that may be optional. As such, this statement is intended to serve as antecedent basis for use of such exclusive terminology as “solely”, “only” and the like in connection with the recitation of claim elements, or the use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present invention.

The disclosure is related to an invention solves the stress concentration issues on a flexible pipe connector by creating a de-stressed section that transforms the stress-concentration on the circumference of the end of the flexible pipe connector to the longitudinal direction of the flexible pipe connector by allowing a stretch of the material longitudinally to avoid the rippling distortion on the circumference of the end of the flexible pipe connector. The de-stressed section is configured to be away from the location where the clamp contacts the end of the flexible pipe connection. Therefore, the stretch or even a distortion on the de-stressed section would not leave a gap on or near the location where the clamp contacts with the end of the flexible pipe connection and will prevent the leakage from occurring.

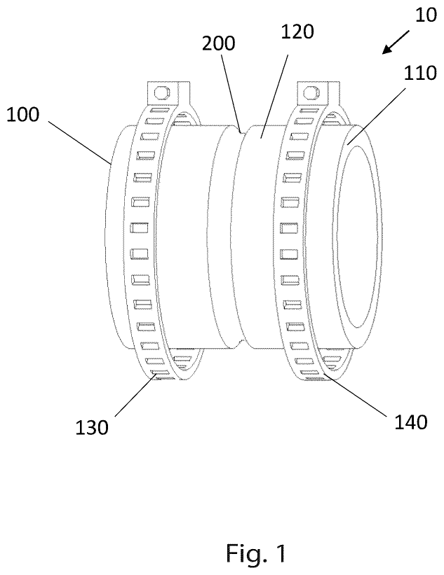

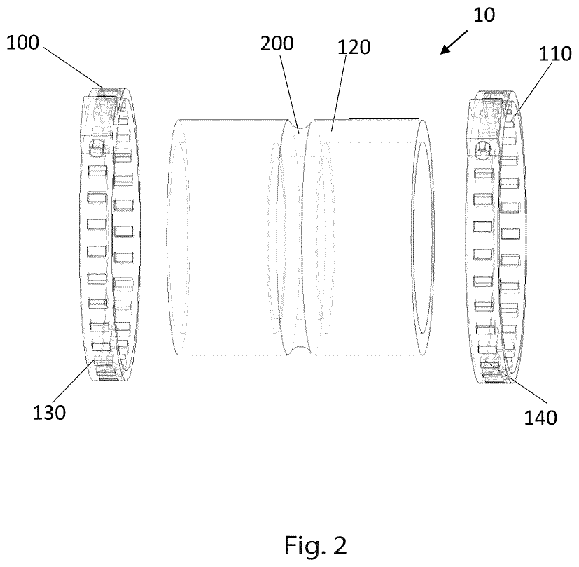

As disclosed in FIGS. 1 and 2, in one of the embodiments of the invention, a flexible pipe connector 10, comprises a first pipe receiving end 100, a second pipe receiving end 110 opposing to the first pipe receiving end 100, a body 120 configured between the first pipe receiving end 100 and the second pipe receiving end 110, a first tightener 130 near the first pipe receiving end 100, a second tightener 140 near the second pipe receiving end 110, and a de-stressed section 200 formed on the body 120 configured to redistribute a stress concentrated on the first pipe receiving end 100 and the second pipe receiving end 110.

In one embodiment of the invention, the flexible pipe connector 10, of which the de-stressed section wall 202 is configured to be deformed when a stress is to be concentrated on the first pipe receiving end 100 or second pipe receiving end 110 or the de-stressed section wall 202 is configured to distribute the stress in a longitudinal direction of the body 200 when the stress is applied on the first pipe receiving end wall 102 or the second pipe receiving end wall 112. In this way, the de-stressed section 200 will redistribute the stress to be concentrated on the first pipe receiving end or second pipe receiving end to the de-stressed section. To achieve this redistribution effect, in one of the embodiments of the invention, the de-stressed section 200 and the de-stressed section wall 202 could be configured in several ways detailed below.

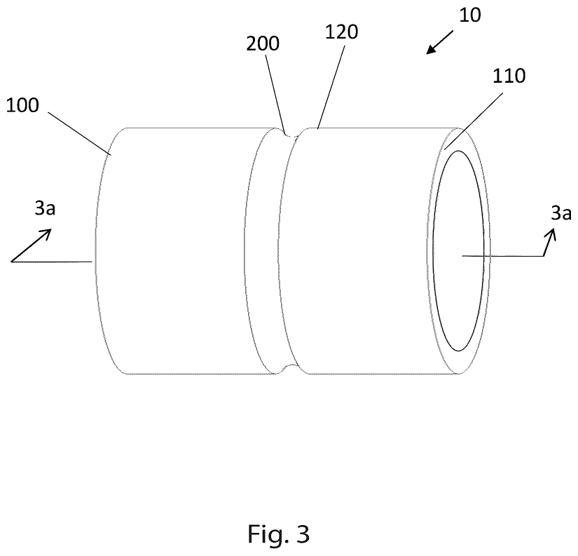

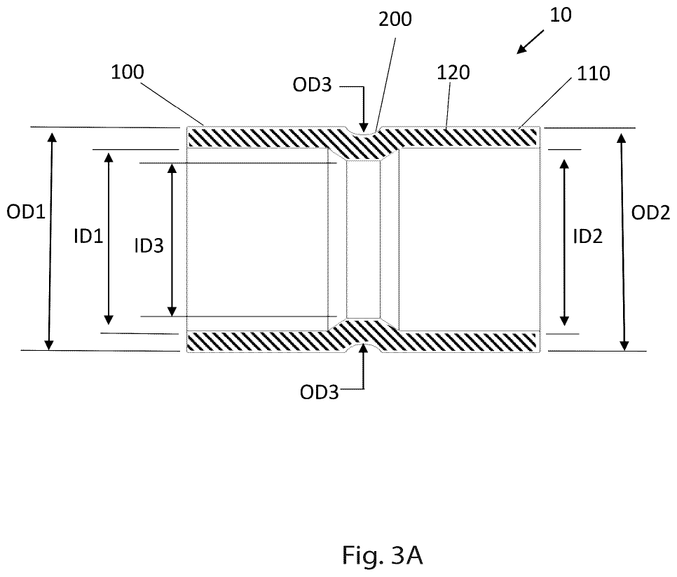

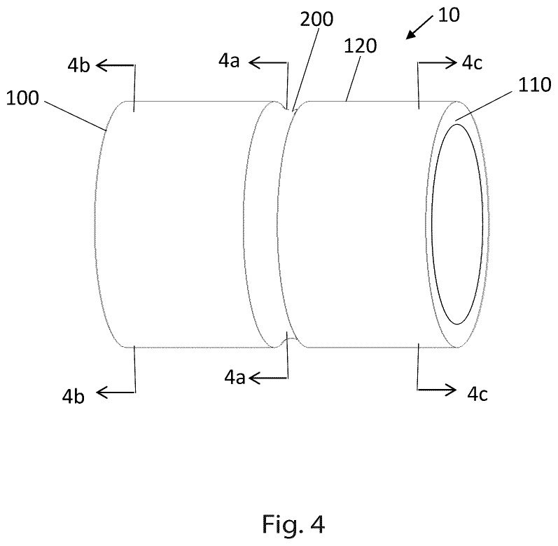

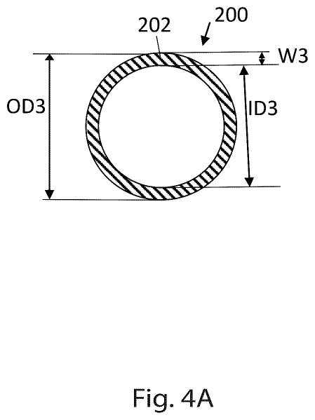

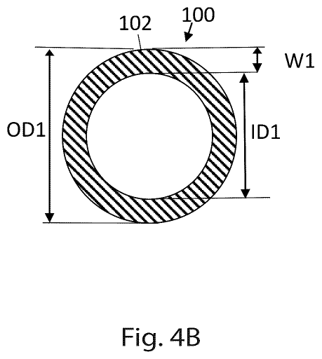

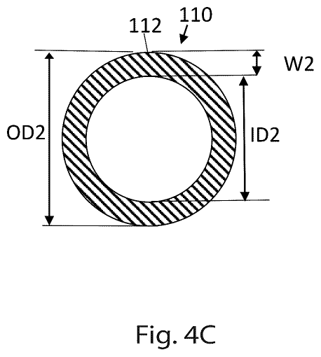

As shown in FIGS. 1, 3, 3a, 4, and 4a, in one embodiments of the invention, the de-stressed section 200 is configured to have a sectional outer diameter OD3 of the de-stressed section 200 less than a first outer diameter OD1 of the first pipe receiving end 100 and a second outer diameter OD2 of the second pipe receiving end 110.

As shown in FIGS. 1, 3, 3a, 4 and 4a, in one embodiments of the flexible pipe connector, the de-stressed section 200 is configured to have a sectional inner diameter ID3 of the de-stressed section 200 less than a first inner diameter ID1 of the first pipe receiving end 100 and a second inner diameter ID2 of the second pipe receiving end 110.

As shown in FIGS. 1, 3, 3a, 4 and 4a, in one embodiment of the invention, the de-stressed section 200 further comprises a de-stressed section wall 202, wherein the first pipe receiving end 100 further comprises a first pipe receiving end wall 102, and wherein the second pipe receiving 110 end further comprises a second pipe receiving end wall 112.

In one embodiment of the invention, the de-stressed section wall 202 is configured to be more flexible than the first pipe receiving end wall 102 and the second pipe receiving end wall 112. This more flexible configuration of the de-stressed section wall 202 can be achieved by several means, including but not limited to configure the de-stressed section wall 202 is thinner than the thickness of the first pipe receiving end wall 102 and the second pipe receiving end wall 112, or to configure the de-stressed section wall 202 to have a lower Young's modulus less than a Young's modulus of the first pipe receiving end wall 102 or a Young's modulus of the second pipe receiving end wall 112.

As shown in FIGS. 1, 3, 3a, 4 and 4a, in one embodiment of the invention, the de-stressed section wall 202 is configured to be thinner than the first pipe receiving end wall 102. As shown in FIGS. 1, 3, 3a, 4 and 4a, in one embodiment of the invention, the de-stressed section wall 202 is configured to be thinner than the second pipe receiving end wall 112.

What is claimed:

1. A flexible pipe connector, comprising
a. a first pipe receiving end,
b. a second pipe receiving end opposing to the first pipe receiving end,
c. a body configured between the first pipe receiving end and the second pipe receiving end,
d. a first tightener near the first pipe receiving end,
e. a second tightener near the second pipe receiving end, and
f. a de-stressed section formed on the body configured to redistribute a stress concentrated on the first pipe receiving end and the second pipe receiving end.

2. The flexible pipe connector in claim 1, wherein the de-stressed section is configured to have a sectional outer diameter of the de-stressed section less than a first outer diameter of the first pipe receiving end and a second outer diameter of the second pipe receiving end.

3. The flexible pipe connector in claim 1, wherein the de-stressed section is configured to have a sectional inner diameter of the de-stressed section less than a first inner diameter of the first pipe receiving end and a second inner diameter of the second pipe receiving end.

4. The flexible pipe connector in claim 1, wherein the de-stressed section further comprises a de-stressed section wall, wherein the first pipe receiving end further comprises a first pipe receiving end wall, and wherein the second pipe receiving end further comprises a second pipe receiving end wall.

5. The flexible pipe connector in claim 4, wherein the de-stressed section wall is configured to be more flexible than the first pipe receiving end wall and the second pipe receiving end wall.

6. The flexible pipe connector in claim 4, wherein the de-stressed section wall is configured to be thinner than the first pipe receiving end wall.

7. The flexible pipe connector in claim 4, wherein the de-stressed section wall is configured to be thinner than the second pipe receiving end wall.

8. The flexible pipe connector in claim 4, wherein the de-stressed section wall is configured to be deformed when a stress is to be concentrated on the first pipe receiving end.

9. The flexible pipe connector in claim 4, wherein the de-stressed section wall is configured to be deformed when a stress is to be concentrated on the second pipe receiving end.

10. The flexible pipe connector in claim 4, wherein a Young's modulus of the de-stressed section wall is less than a Young's modulus of the first pipe receiving end wall and Young's modulus of the second pipe receiving end wall.
